(19) United States
(12) Patent Application Publication
(10) Pub. No.: US 2009/0225829 A2
(43) Pub. Date: Sep. 10, 2009

(54) METHOD AND APPARATUS FOR OPERATIONAL FRAME-LAYERRATE CONTROL IN VIDEO ENCODER

(76) Inventors: Do-Kyoung Kwon, Yongin (KR); Meiyin Shen, Kao-Hsiung City (TW); Chung-Chieh KUO, Taipei City (TW)

Correspondence Address: NORTH AMERICA INTELLECTUAL PROPERTY CORPORATION, P.O. BOX 506, MERRIFIELD, VA, 22116, UNITED STATES, 302-729-1562, 806-498-6673, winstonhsu.uspto@gmail.com

(21) Appl. No.: 11/160,735

(22) Filed: Jul. 6, 2005

(51) Int. Cl. H04N 11/04

(52) U.S. Cl. 375/240.03; 375/240.24

(57) ABSTRACT

A method of frame-layer rate control in a video encoder includes allocating a target characteristic for a current frame, performing a first encoding stage for encoding macroblocks of the current frame by utilizing a first quantization parameter to thereby generate a residual signal and an actual characteristic for the current frame corresponding to being encoded according to the first quantization parameter, and testing whether or not the actual characteristic for the current frame corresponding to being encoded with the first quantization parameter is within a predetermined range of the target characteristic for the current frame.

### BACKGROUND

The invention generally relates to rate control for block-based video encoders, and in particular to a method and apparatus for performing operational frame-layer rate control in H.264 video encoders.

Various video compression standards have been developed for a wide range of applications such as video telephony, video conferencing, and video streaming. These video coding standards typically involve techniques including discrete cosine transform (DCT), motion estimation (ME) or motion compensation (MC), quantization, and variable length coding (VLC). A quantization parameter (QP), which corresponds to a quantization step-size, is utilized during the quantization process and is an important encoding parameter that has a large effect on the quality of resulting encoded video. The quantizer step-size used for a frame or a macroblock (MB) impacts the encoded video quality, and an appropriate rate control algorithm should be utilized to determine the quantizer step-size for a given application and coding environment. That is, the QP value should be determined carefully for a given application and video compression standard.

Due to its importance, although not strictly belonging to the scope of standards, rate control has been studied extensively by many researchers. Recently, the H.264 video compression standard has received much attention due to its improved coding efficiency. Accordingly, finding an efficient rate control algorithm for use by H.264 encoders has become an important topic for the practical usage of H.264 with various transmission channels, and several model-based rate control algorithms have been proposed for H.264.

The rate and distortion (R-D) optimized motion estimation and mode decision (also referred to as RDO) with various intra and inter prediction modes and multiple reference frames is a major contributor to the high coding efficiency of H.264 compared with the previous video compression standards. However, rate control (RC) of H.264 is complicated due to the inter-dependency between the RDO and RC. That is, RC is utilized to determine a QP value, and the QP value is utilized by the RDO to determine the necessary information for RC. This issue of which parameter to determine first is sometimes referred to as the chicken and egg dilemma and is identified in “Adaptive frame layer rate control for H.264” by Z. G. Li, F. Pan, K. P. Lim, G. N. Feng, S. Rahardja and D. J. Wu, in Proc. IEEE Intl. Conf. Multimedia and Expo, pp. 581-584, June 2003; and “Adaptive rate control for H.264” by Z. G. Li, F. Pan, K. P. Lim, and S. Rahardja, in Proc. IEEE Intl. Conf. Image Processing, pp. 745-748, October 2004.

To resolve the RDO and RC inter-dependency problem, several model-based rate control algorithms have been proposed with their own approaches. In both documents mentioned above, the mean absolute difference (MAD) of each basic unit in the current frame is estimated according to the MAD of the collocated basic unit in the previous frame using a linear model. A quadratic rate model is then employed to determine the QP of the basic unit, which could be a frame, a slice, or a macroblock (MB). In “A new rate control scheme for H.264 video coding” by P. Yin and J. Boyce, in Proc. IEEE Intl. Conf. Image Processing, pp. 449-452, October 2004, the variance of the residual signal is estimated after performing the RDO with a reduced set of MB partitions and reference frames. The estimated variance is fed into the H.263 TMN8 R-D models described in “Rate control in DCT video coding for low-delay communications,” by J. Ribas-Corbera and S. Lei, IEEE Trans. Circuits and Syst. Video Technol., vol. 9, pp. 172-185, February 1999, to determine the QP values of MBs.

Other rate control algorithms using the similar approaches also have been proposed for H.264 as described in “A new bit rate control strategy for H.264” by N. Wang and Y. He, in Proc. IEEE Intl. Conf. Infor. Commun. and Signal Processing, pp. 1370-1373, December 2003; “A novel rate control scheme for H.264 video coding,” by J. Xu and Y. He, in Proc. IEEE Intl. Symp. Circuits and Systems, pp. III-809-812, May 2004.

While the estimation methods in the previous algorithms may work for stable video sequences, the accuracy cannot be guaranteed when video sequences contain frames with variable characteristics, for which the rate control performance decreases due to inaccurate estimation of MAD and/or variance of the residual signal. An improved method of performing frame rate control in H.264 video encoders would be greatly beneficial.

### SUMMARY OF THE INVENTION

One objective of the embodiments of the claimed invention is therefore to provide an operational method of frame-layer rate control to solve the above-mentioned problems.

Some embodiments of the frame-layer rate control method comprise allocating a target characteristic for a current frame; performing a first encoding stage for encoding macroblocks of the current frame by utilizing a first quantization parameter to thereby generate a residual signal and an actual characteristic for the current frame corresponding to being encoded according to the first quantization parameter; and testing whether or not the actual characteristic for the current frame corresponding to being encoded with the first quantization parameter is within a predetermined range of the target characteristic for the current frame. In some embodiments, if the actual characteristic is not within the predetermined range of the target characteristic, the method further comprises finding a second quantization parameter by performing a second encoding stage to encode the residual signal for the current frame.

Some embodiments of an apparatus are disclosed for performing frame-layer rate control in a video encoder. The apparatus comprises a target characteristic allocating unit for allocating a target characteristic for a current frame; a first stage encoding device being coupled to the target characteristic allocating unit for performing a first encoding stage for encoding macroblocks of the current frame by utilizing a first quantization parameter to thereby generate a residual signal and an actual characteristic for the current frame corresponding to being encoded according to the first quantization parameter; and a rate control device being coupled to the first stage encoding device for testing whether or not the actual characteristic for the current frame corresponding to being encoded with the first quantization parameter is within a predetermined range of the target characteristic for the current frame. In some embodiments, the apparatus further comprises a second stage encoding device being coupled to the rate control device, where the second stage encoding device finds a second quantization parameter by performing a second encoding stage to encode the residual signal for the current frame if the rate control device determines that the actual characteristic is not within the predetermined range of the target characteristic.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates the basic idea of a two-stage encoding process.

FIG. 2 shows a block diagram illustrating a video encoding system for performing operational rate control according an exemplary embodiment of the present invention.

FIG. 3 shows how upper and lower bounds set for the target bits to allow early termination.

FIG. 4 illustrates a flowchart describing a method of frame-layer rate control based on a two-stage encoding scheme for constant bit rate according to an exemplary embodiment of the present invention.

FIG. 5 shows a first QP₂ decision method of the video encoding system of FIG. 2.

FIG. 6 shows a second QP₂ decision method of the video encoding system of FIG. 2.

FIG. 7 shows a third QP₂ decision method of the video encoding system of FIG. 2.

FIG. 8 shows a fourth QP₂ decision method of the video encoding system of FIG. 2.

FIG. 9 shows the actual bit rates and the average number of encoding times per frame (N.E) for different values of B_{L}.

FIG. 10 shows the bit variations for different values of the lower bound B_{L} for the QCIF “silent” sequence.

FIG. 11 shows the bit variations for different values of the lower bound B_{L} for the QCIF “hall” sequence.

FIG. 12 shows the distribution of the difference between the first quantization parameter and the second quantization parameter (QP₁-QP₂) for all tested sequences encoded utilizing the rate control method for constant bit rate according to an embodiment of the present invention.

FIG. 13 shows a flowchart describing a method of frame-layer rate control based on a two-stage encoding scheme for constant quality according to an exemplary embodiment of the present invention.

FIG. 14 illustrates a flowchart of a generalized method of operational frame-layer rate control based on a two-stage encoding scheme according to an exemplary embodiment of the present invention.

### DETAILED DESCRIPTION

In H.264 rate control, there are two major problems caused by the inter-dependency between the rate and distortion optimization (RDO) and the rate control (RC) process. Firstly, as addressed in the related art documents and their associated algorithms, the residual signal and its related information such as mean absolute difference (MAD) and variance are not available before the RDO is performed. Secondly, the header information such as macroblock (MB) modes, motion vectors (MVs) and reference frames are also not known before the RDO is performed. As a result, the number of header bits required for encoding the header information cannot be accurately estimated.

Several rate control methods have been proposed for H.264 with their own solutions to the RDO-RC inter-dependency problem. However, these solutions do not solve all problems caused by the RDO-RC inter-dependency. In U.S. patent application Ser. No. 11/047,039, entitled “Video Encoding Methods and Systems With Frame-Layer Rate Control”, filed on Jan. 31, 2005 by the same inventor and incorporated herein by reference, a frame-layer rate control algorithm based on a two-step encoding scheme is described. As explained, the two-step encoding scheme resolves the problems caused by the RDO-RC inter-dependency.

The solutions of the related art including the two-step encoding scheme disclosed above by the same inventor are model-based approaches in which the quantization parameter (QP) is determined using rate and distortion models to control bit rates. The performances of the model-based rate control methods depend largely on the accuracy of the rate and distortion models. That is, even a small estimation error may degrade the rate control performance considerably. Although the disclosed two-step encoding scheme resolves the RDO-RC inter-dependency problem, performance degradation is sometimes encountered due to modeling errors. According to some embodiments of the present invention, an operational rate control method is disclosed to ensure that the encoding process meets a target characteristic being allocated for each frame before the frame is encoded. For example, embodiments are shown where the bit rate or the quality of the video bit stream remains substantially constant throughout the encoding process. Although requiring a high encoding complexity, the operational rate control method and apparatus may prevent performance degradation due to modeling errors.

In H.264, the R-D optimization using the Lagrange optimization technique is employed. During this process, the H.264 encoder chooses the best coding parameters such that the Lagrange cost is minimized, where the Lagrange multipliers are functions of the given QP. In “Combined mode selection and macroblock quantization step adaptation for the H.263 video encoder” published in Proc. IEEE Intl. Conf. Image Processing, pp. 26-29, October 1997, a joint MB mode and QP selection using the Lagrange optimization technique has been proposed and implemented in the H.263 encoder. In this proposal, the Lagrange multipliers are adjusted via iterative encoding such that the target bit rate is satisfied.

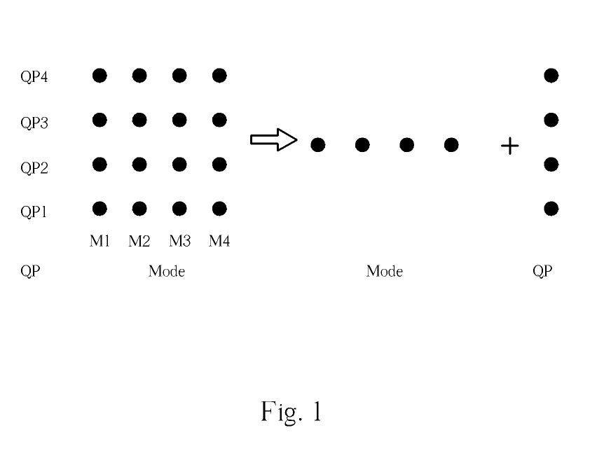

FIG. 1 shows the basic idea of a two-stage encoding process according to an embodiment of the present invention. As illustrated in FIG. 1, a two-dimensional (2-D) search space such as that described in the above mentioned reference is converted into a cascaded one-dimensional (1-D) search space. More specifically, given an initial QP, the 1-D search for the best MB mode takes place first through the RDO. Then, another 1-D search for the final QP takes place to meet the target bit rate. The cascaded 1-D search is a sub-optimal solution to the joint search on the 2-D space. However, the coding gain loss caused by the cascaded 1-D search is insignificant when the difference between the initial QP and the final QP is restricted to a small range as shown in Formula 1:
|QP₁−QP₂|≦Δwhere Δ=3 [1]

where QP₁ and QP₂ are the initial and final QP, respectively.

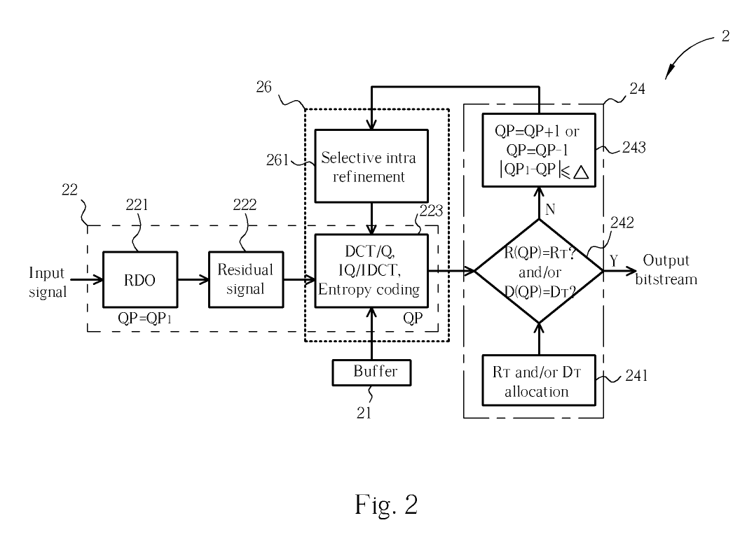

FIG. 2 shows a block diagram illustrating an embodiment of a video encoding system 2 for performing operational rate control according an exemplary embodiment of the present invention. In this embodiment, the video encoding system 2 comprises a first stage encoding device 22, a rate control device 24, and a second-stage encoding device 26. The first stage encoding device 22 comprises an RDO unit 221, a residual storage unit 222, and a discrete cosine transform (DCT)/quantization-inverse quantization (Q-IQ)/inverse discrete cosine transform-entropy (IDCT-entropy) coding unit 223, hereafter referred to as the DCT/Q-IQ/IDCT-entropy coding unit 223. In this embodiment, the first stage encoding device 22 determines the average value of quantization parameters for all macroblocks in a previous frame. In the RDO unit 221, using the average value of the quantization parameters as a first quantization parameter QP₁, the R-D optimized motion estimation and mode decision is performed for all MBs in the frame. The residual signal and the header information from the RDO unit 221 are stored in the residual storage unit 222. The DCT/Q-IQ/IDCT-entropy coding unit 223 generates the reconstructed frame and a temporary bit stream.

The rate control device 24 is coupled to the first stage encoding device 22 for testing whether or not an actual characteristic for the current frame after being encoded with the first quantization parameter QP₁ is within a predetermined range of the target characteristic for the current frame. In this embodiment, the rate control device 24 comprises a target characteristic allocating unit being a number of target bits and/or a target distortion allocating unit 241, a condition testing unit 242, and a quantization parameter QP updating unit 243. According to different embodiments, the target characteristic allocating unit is for allocating a target characteristic for a current frame such as allocating the target number of bits R_{T} corresponding to the rate and/or the target distortion D_{T} of the resulting encoded frame. The condition testing unit 242 is for testing whether or not the actual characteristic for the current frame corresponding to being encoded with the first quantization parameter QP₁ is within a predetermined range of the target characteristic for the current frame. If the actual number of bits and/or the actual distortion are close to the target number of bits and the target distortion, i.e., if the actual rates are within the predetermined range, an output bit stream is generated from the temporary bit stream. That is, if the rate control device determines that the actual characteristic is within the predetermined range of the target characteristic, the video encoding system 2 generates a video bit stream according to the residual signal being encoded with the first quantization parameter QP₁. If not, the QP updating unit 243 increases (or decreases) the first quantization parameter QP₁ by one for the second-stage of encoding. Note that in the QP updating unit 243, the updated quantization parameter QP is restricted to be within the range of (QP₁−Δ, QP₁+Δ). By restricting the difference between the two QP values of two successive frames, the rate control device 24 prevents an abrupt quality change between the successive frames.

The second-stage encoding device 26 comprises a selective intra refinement unit 261, and a DCT/Q-IQ/IDCT-entropy coding unit 223. As shown in FIG. 2, to save hardware costs, in this embodiment, both the second-stage encoding device 26 and the first stage encoding device 22 share the same DCT/Q-IQ/IDCT-entropy coding unit 223. The selective intra refinement unit 261 is activated only when a MB mode in the first stage of encoding is one of the intra prediction modes. Since the quantization and inverse quantization are performed using a different QP from that utilized in the first stage of encoding, the neighboring reconstructed MBs are different from those in the first stage of encoding. Therefore, when the MB is of intra mode, the residual signal of the MB is refined again using the intra mode determined in the first stage encoding device 22. In this way, the rate control device 24 refines the residual signals of intra macro blocks (MBs) utilizing neighboring reconstructed pixels in the second stage of encoding.

The DCT/Q-IQ/IDCT-entropy coding unit 223 generates the reconstructed frame and temporary bit stream again by encoding the residual signal from the first stage of encoding. A difference between the two-stage encoding scheme of the present invention and the two-step encoding scheme of the above-referenced invention by the same inventor is that in the present invention the entropy coding also takes place in the first stage and the residual signal may be encoded several times in the second stage. The term “stage” is used herein instead of “step” due to the fact that the residual signal may be encoded multiple times in the second stage.

An exemplary embodiment of an operational rate control that achieves constant bit rate (CBR) for H.264 is described as follows. In this embodiment, given the target bits R_{T} for the current frame, rate control is performed to provide a constant bit rate. During the first stage of encoding, the RDO is performed using the first quantization parameter QP₁, and the residual signal is encoded via the DCT/Q, IQ/IDCT and entropy coding. For example, the first quantization parameter QP₁ can be the QP or the average QP value of the previous frame. After the RDO, DCT/Q, IQ/IDCT and entropy coding are performed, the actual number of bits R(QP₁) for the current frame as a result of using the first quantization parameter QP₁ becomes available. During the second stage of encoding, according to the values of R(QP₁) and R_{T}, the residual signal is then encoded using all QP values within the range of (QP₁+1, QP₁+Δ) or (QP₁−Δ, QP₁−1) to obtain actual numbers of bits corresponding to each of the possible QP values. Note that the QP values are kept within the range of (QP₁+1, QP₁+Δ) or (QP₁−Δ, QP₁−1) to ensure the difference between the initial QP₁ and the final QP₂ is restricted to a small range. Finally, the residual signal is again coded using the second quantization parameter QP₂, which is the QP that gives the minimum distance between R(QP) and R_{T}, where QPε(QP₁, QP₁+Δ) or QPε(QP₁−Δ, QP₁).

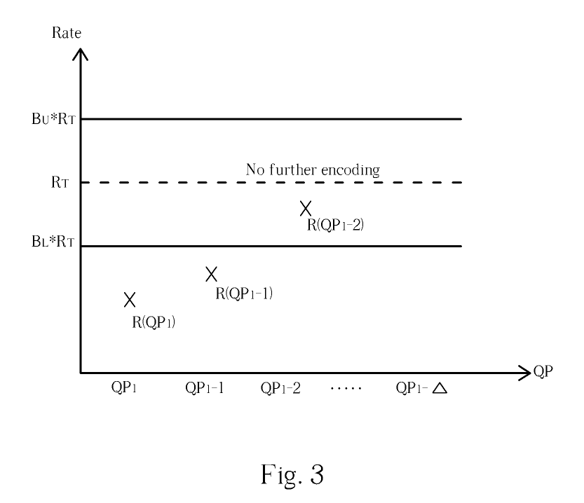

In general, the above algorithm according to this embodiment requires one RDO and Δ+2 times of the DCT/Q, IQ/IDCT, and entropy coding operations for each frame. To reduce the computational cost, i.e., the number of encoding times required during the second stage of encoding, a heuristic method is disclosed in the next embodiment as shown in FIG. 3. Note that the actual numbers of bits of the frame are allowed to deviate to some extent from the target bits since an encoder buffer can absorb variable bit rates. Therefore, upper and lower bounds around the target bits are employed by the heuristic method of this embodiment for early termination. As shown in FIG. 3, let B_{U}×R_{T} and B_{L}×R_{T} be the upper and lower bounds around the target bits, respectively. Then, if R(QP) falls into the range indicated by (B_{L}×R_{T}, B_{U}×R_{T}), for example, further encoding using other QP values does not take place. Encoding operations are thereby greatly reduced.

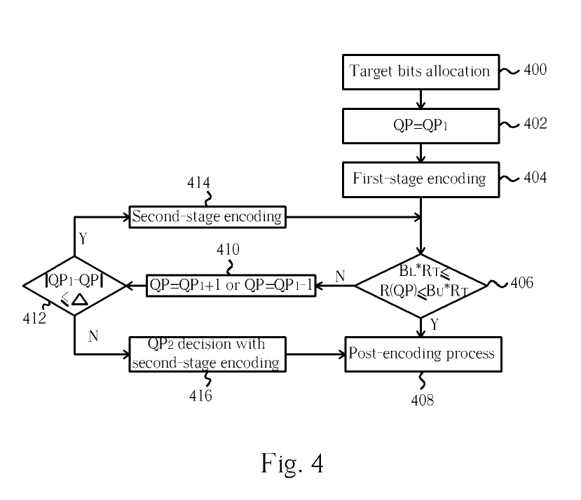

FIG. 4 illustrates a flowchart describing a method of frame-layer rate control based on a two-stage encoding scheme for constant bit rate according to an exemplary embodiment of the present invention. Provided that substantially the same result is achieved, the steps of the flowchart in FIG. 4 need not be in the exact order shown and need not be contiguous, that is, other steps can be intermediate. In this embodiment, frame-layer rate control to achieve constant bit rate includes the following steps:

Step 400: Allocate a number of target bits for the current frame.

Step 402: Initialize a QP variable to be equal to a starting value of the first quantization parameter QP₁. For example, the first quantization parameter QP₁ can be the QP or the average QP value of the previous frame.

Step 404: Perform the first stage of encoding utilizing the QP variable being equal to the first quantization parameter QP₁ as set at step 402.

Step 406: Test conditions for early termination.

Step 408: Perform the post-encoding process.

Step 410: Update the QP variable for the next iteration.

Step 412: Validate the QP value to ensure it is within a predetermined range of the first quantization parameter QP₁.

Step 414: Perform the second stage of encoding utilizing the updated QP variable.

Step 416: Decide on a second quantization parameter QP₂ according to the results of the second stage of encoding.

At step 400, the target number of bits for the current frame R_{T} is allocated to achieve a constant bit rate. It should be noted that the bit allocation method is not a focus of the present invention, and various methods of the related arts can be used to perform step 400. At step 402, the QP variable is initialized to the first quantization parameter QP₁, which in this embodiment is set to the QP value of the previous frame. Next, at step 404, the first stage of encoding is performed via the RDO, DCT/Q, IQ/IDCT, and entropy coding using the QP initialized during step 402. Afterwards, the reconstructed frame and a temporary bit stream are generated. At step 406, R(QP) is tested to determine whether it falls within the range of (B_{L}×R_{T}, B_{U}×R_{T}). If so, the output bit stream is generated from the temporary bit stream, i.e., QP₂=QP and the buffer state is updated at step 408. Otherwise, if R(QP) is not within the range of (B_{L}×R_{T}, B_{U}×R_{T}, the QP value is increased or decreased by one at step 410. More specifically, if R(QP) is larger than R_{T}, the QP variable is decreased by one, and if R(QP) is larger than R_{T}, the QP variable is increased by one.

Step 412 checks whether the difference between the QP variable and the first quantization parameter QP₁ is less than or equal to a predetermined difference Δ. If so, at step 414, the second stage of encoding of the residual signal from the first stage of encoding 404 is performed via DCT/Q, IQ/IDCT, and entropy coding utilizing the new QP variable. Afterwards, step 406 is again executed. If the difference between the QP variable and the first quantization parameter QP₁ is greater than the predetermined difference Δ, the second quantization parameter QP₂ is determined as the QP that gives the minimum distance between R(QP) and R_{T}, where QPε(QP₁, QP₁+Δ) or QPε(QP₁−Δ, QP₁). Next, the residual signal is again encoded if necessary at step 416. That is, if the last QP used to encode residual signal is the same as the determined QP₂, the additional encoding is not necessary in step 416.

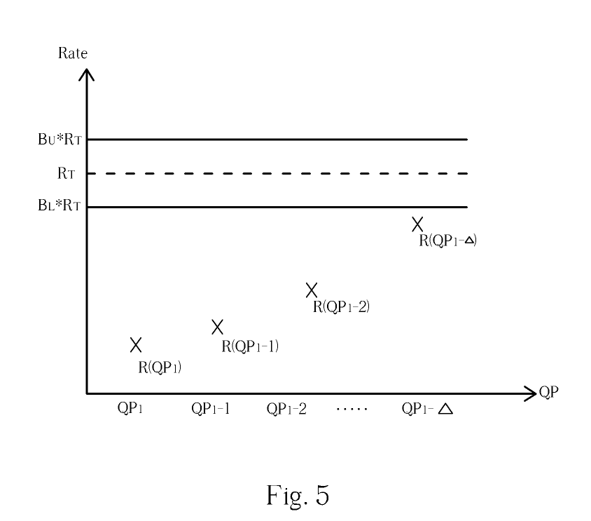

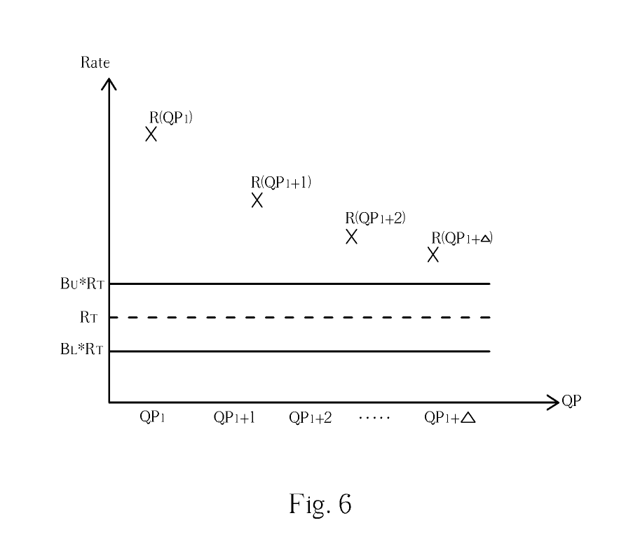

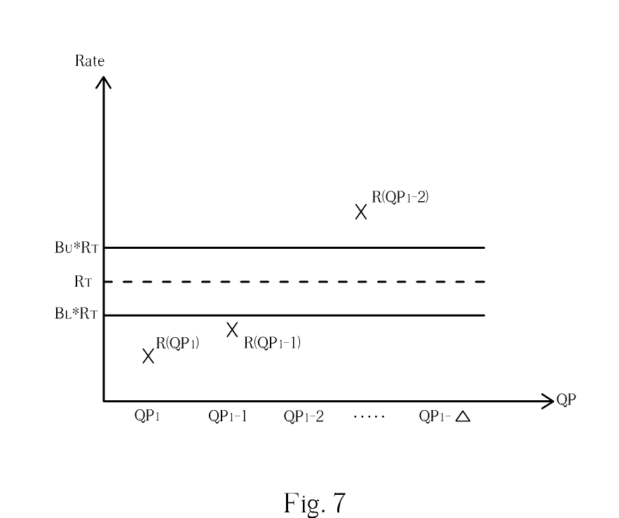

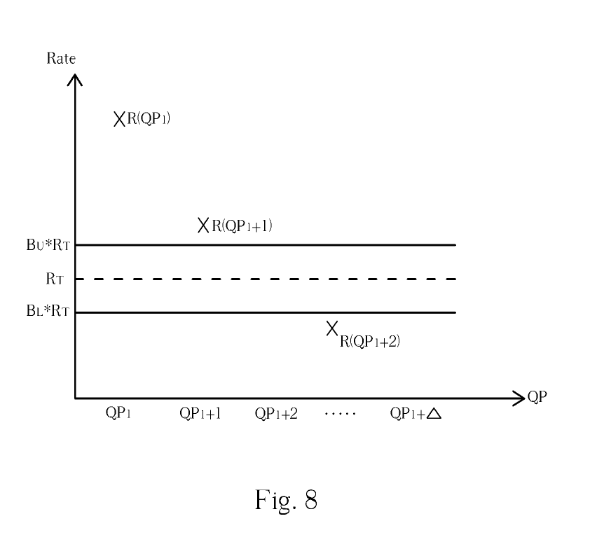

To increase the quality of the resulting video sequences, different QP₂ decision methods can be employed during step 416. FIG. 5-FIG. 8 show four different cases, respectively. In the cases shown in FIG. 5 and FIG. 6, the QP that gives R(QP) closest to R_{T} is chosen in step 416 as the second quantization parameter QP₂. Alternatively, in the cases shown in FIG. 7 and FIG. 8, the QP that gives R(QP) just larger than R_{T} is chosen as the second quantization parameter QP₂ as long as the buffering mechanism of the encoder does not overflow. That is, a buffer 21 being coupled to the second-stage encoding device 26 utilized during the encoding process of the second encoding stage should not overflow when using the chosen second quantization parameter QP₂. After step 416, the buffer state is updated in step 408. It should also be noted that, in this embodiment, the value of predetermined difference Δ is set to 3; although other values are also possible.

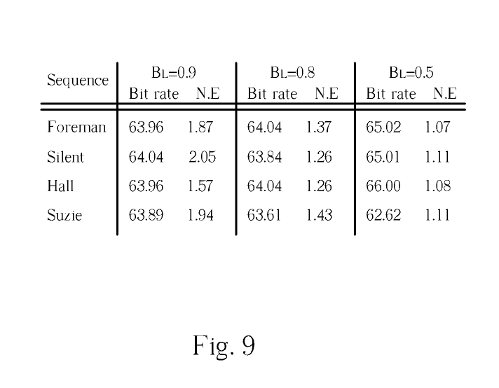

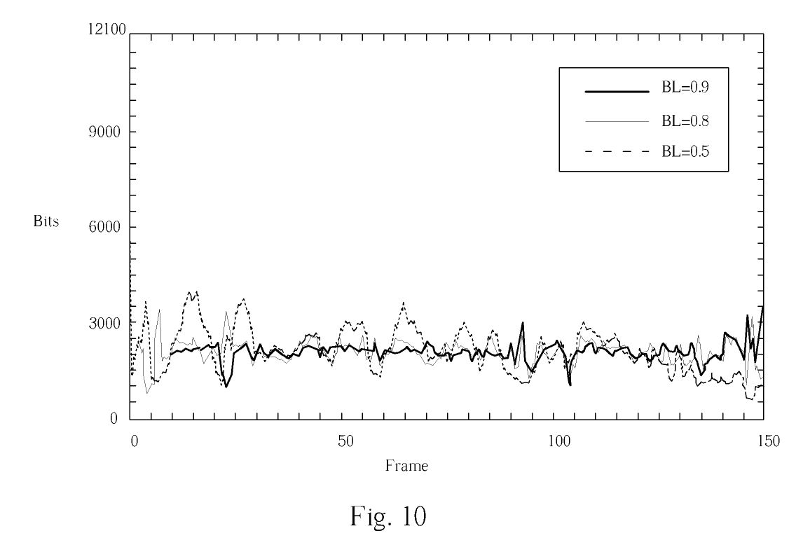

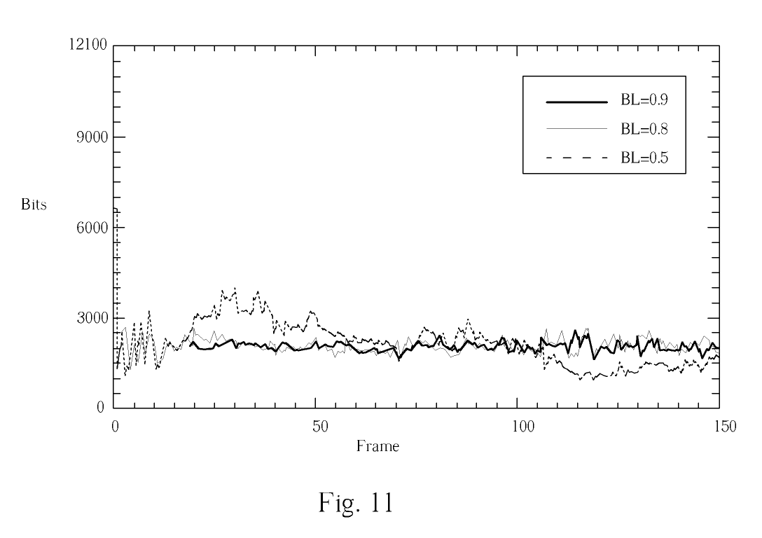

In some embodiments of the present invention for constant bit rate, the values of B_{U} and B_{L} are set to be the reciprocal of each other, i.e., B_{L}=1/B_{U}. The B_{U} and B_{L} values determine the number of encoding times in the second stage of encoding as well as the amount of bit variations. According to experimental testing, several QCIF-format sequences are encoded at 64 Kbps with different values of B_{L} being 0.9, 0.8 and 0.5. A total of 150 frames are encoded as P frames except the first I frame. In the experimental testing, the buffer size is assumed to be sufficiently large. FIG. 9 shows the actual bit rates and the average number of encoding times per a frame (N.E) for different values of B_{L}. The value of N.E represents the encoding complexity. For example, an N.E value equal to 1.37 means 37 frames out of 100 frames go through DCT/Q, IQ/IDCT and entropy coding an additional time in the second stage of encoding. Additionally, FIG. 10 and FIG. 11 show the bit variations for different values of B_{L}. As shown from FIG. 9, and FIG. 10 and FIG. 11, the bit rates and bit variation with B_{L}=0.9 and 0.8 are similar while reducing the N.E significantly with B_{L}=0.8. For this reason, in this embodiment, the value of B_{L} is set to 0.8, and the value of B_{U} is set to the inverse being 1/0.8.

Due to the non-stationary characteristics of video sources, video sequences encoded according to the above described constant bit rate embodiment may be subject to significant quality variations. On the other hand, while a constant quality of the resulting video sequences can be provided if an infinite buffer is available, maintaining a constant quality may result in the constant bit rate constraint not being achieved. Therefore, in order to mitigate quality variations with a limited buffer size under the constant bit rate (CBR) constraint, a rate control method according to a second embodiment of the present invention operates by compromising between the quality and the bit rate of the resulting encoded video sequence.

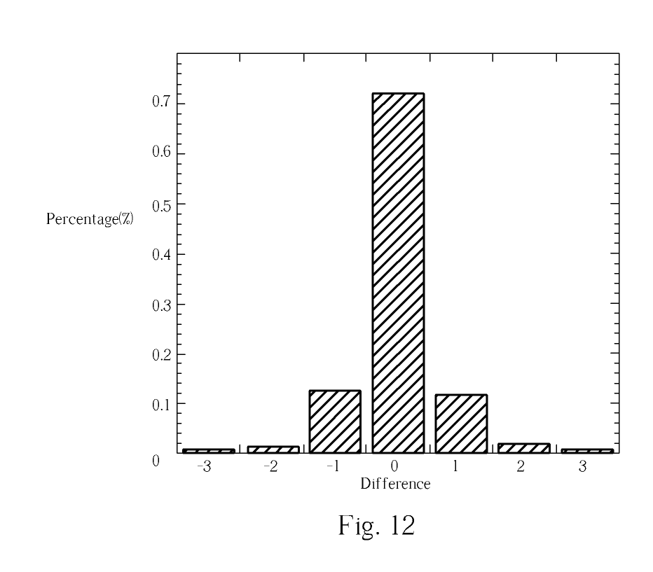

In the second embodiment, the target characteristic allocating unit 241 allocates a target characteristic for the current frame being a target number of bits and a target distortion for the current frame; and the actual characteristic comprises an actual number of bits and an actual distortion of the current frame after being encoded. Additionally, in this embodiment for constant quality, both the target bit rate R_{T} and the target distortion D_{T} are employed to determine the second quantization parameter QP₂ of the current frame. For example, in one embodiment, the value of D_{T} is set to the average mean squared error (MSE) of the previous frames. FIG. 12 illustrates the distribution of the difference between the first quantization parameter and the second quantization parameter (QP₁−QP₂) for all tested sequences encoded utilizing the rate control method for constant bit rate according to this embodiment of the present invention. As shown, the probability that |QP₁−QP₂|≦1 is larger than 0.95, which means abrupt quality change only occurs for 5% of the total frames. Thus, assuming that the same QP values produce the same qualities of frames, the rate control method according to this embodiment can operate for constant quality by adjusting the QP values at the frames having abrupt quality change.

Given the target bit R_{T} and target distortion D_{T} for the current frame, rate control for constant quality is performed in this embodiment as described in the following. Let B_{U}^{d}×D_{T} and B_{L}^{d}×D_{T} be the upper and lower bounds around the target distortion, respectively. Also let B_{U}×R_{T} and B_{L}×R_{T} be the upper and lower bounds around the target bits, respectively. Firstly, the QP value that results in the distortion D(QP) falling into the bounds (B_{L}^{d}×D_{T}, B_{U}^{d}×D_{T}) or that results in the minimum distance between D(QP) and D_{T} is identified, where QPε(QP₁−Δ, QP₁+Δ). Then, the QP value is further adjusted by the following rules: if B_{L}×R_{T}≦R(QP)≦B_{U}×R_{T}, QP₂=QP; if R(QP)>B_{U}×R_{T}, the second quantization parameter QP₂=QP+1; otherwise, if R(QP)<B_{U}×R_{T}, the second quantization parameter QP₂=QP−1. Finally, the second quantization parameter QP₂ is clipped to the range of (QP₁−Δ, QP₁+Δ). It should be noted that unlike the rate control for constant bit rate, the buffer may overflow or underflow when performing rate control for constant quality according to this embodiment of the present invention. After finding the second quantization parameter QP₂ by the above rule, it should be examined if the buffer overflows or underflows during R(QP₂). If so, the second quantization parameter QP₂ should be refined such that the buffer neither overflows nor underflows.

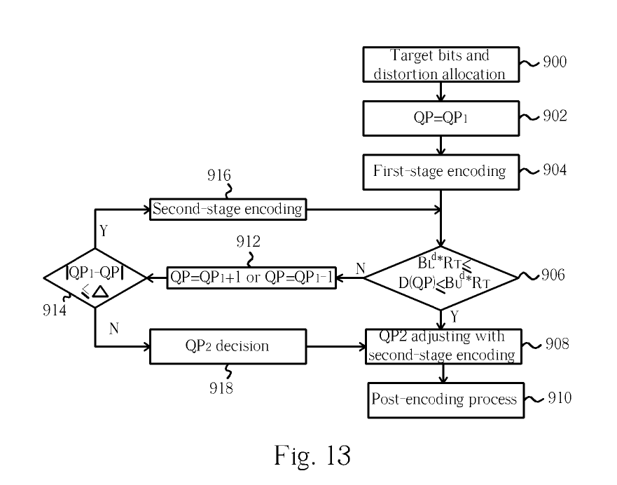

FIG. 13 illustrates a flowchart describing a method of frame-layer rate control based on a two-stage encoding scheme for constant quality according to an exemplary embodiment of the present invention. Provided that substantially the same result is achieved, the steps of the flowchart in FIG. 13 need not be in the exact order shown and need not be contiguous, that is, other steps can be intermediate. In this embodiment, frame-layer rate control to achieve constant quality includes the following steps:

Step 900: Allocate a number of target bits and distortion for the current frame.

Step 902: Initialize a QP variable to be equal to a starting value of the first quantization parameter QP₁. For example, the first quantization parameter QP₁ can be the QP or the average QP value of the previous frame.

Step 904: Perform the first stage of encoding utilizing the QP variable being equal to the first quantization parameter QP₁ as initialized at step 402.

Step 906: Test conditions for early termination.

Step 908: Adjust the second quantization parameter QP₂ with the second stage of encoding.

Step 910: Perform post-encoding process.

Step 912: Update the QP variable for the next iteration.

Step 914: Validate the QP value to ensure it is within a predetermined range of the first quantization parameter QP₁.

Step 916: Perform the second stage of encoding utilizing the updated QP variable.

Step 918: Decide on a chosen second quantization parameter QP₂ according to the results of the second stage of encoding.

At step 900, the target number of bits R_{T} and the target distortion D_{T} are allocated for the current frame. Note that, similar to the previous embodiment, the target number of bits R_{T} is determined assuming a constant bit rate, and methods of the related arts can be used for allocation of the target number of bits R_{T}. Additionally, in this embodiment, the target distortion is set to the average mean square error (MSE) of the previous frames. At step 902, the QP variable is initialized to the first quantization parameter QP₁, which in this embodiment is set to the QP of the previous frame. Next, at step 904, the first stage of encoding is performed via the RDO, DCT/Q, IQ/IDCT, and entropy coding using the QP initialized during step 902. Afterwards, the reconstructed frame and temporary bit stream are generated.

At step 906, D(QP) is tested to determine whether it falls within the range of (B_{L}^{d}×D_{T}, B_{U}^{d}×D_{T}). If so, the QP is further adjusted and the residual signal from the first stage of encoding 904 is encoded again, if necessary, via the DCT/Q, IQ/IDCT, and entropy coding process such that the final bit stream is generated in step 908. The QP is adjusted at step 908 according to the following rules: if B_{L}×R_{T}≦R(QP)≦B_{U}×R_{T}, the second quantization parameter QP₂=QP; if R(QP)>B_{U}×R_{T}, the second quantization parameter QP₂=QP+1; or if R(QP)<B_{U}×R_{T}, the second quantization parameter QP₂=QP−1. Finally, the second quantization parameter QP₂ is clipped to the range of (QP₁−Δ, QP₁+Δ) as long as the buffer neither overflows nor underflows. If the last QP used to encode residual signal is the same as the second quantization parameter QP₂, e.g., B_{L}×R_{T}≦R(QP)≦B_{U}×R_{T}, the additional encoding is not necessary in step 908. After the encoding is finished, the buffer state is updated at step 910. If D(QP) does not fall into the range of (B_{L}^{d}×D_{T}, B_{U}^{d}×D_{T}) in step 906, the QP variable is increased or decreased by one in step 912. More specifically, if D(QP) is smaller than D_{T}, the QP variable is increased by one, and if D(QP) is larger than D_{T}, the QP variable is decreased by one.

Step 914 checks whether the difference between the QP variable and the first quantization parameter QP₁ is less than or equal to a predetermined difference Δ. If so, at step 916, the second stage of encoding of the residual signal from the first stage of encoding 904 is performed using the new QP variable. Afterwards, step 906 is again executed. If the difference between the QP variable and the first quantization parameter QP₁ is greater than the predetermined difference Δ, the QP that gives the gives the minimum distance between D(QP) and D_{T}, where QPε(QP₁, QP₁+Δ) or QPε(QP₁−Δ, QP₁), is identified at step 918. Then, step 908 and step 910 are executed in order to generate the final bit stream and perform the post-encoding process, respectively.

Similar to the previous embodiment for constant bit rate, in this embodiment of the present invention for constant quality, the values of B_{U}^{d} and B_{L}^{d} may also set to be reciprocals of each other, i.e., B_{L}^{d}=1/B_{U}^{d}. Note that the values of B_{U}^{d} and B_{L}^{d} as well as those of B_{U} and B_{L} determine the number of encoding times in the second stage of encoding. Based on experimental trials, in an exemplary embodiment, both values of B_{L} and B_{L}^{d} are set to 0.8, thus B_{U} and B_{U}^{d} are set to 1/0.8. Additionally, the value of the predetermined difference Δ is set to 3 in this embodiment.

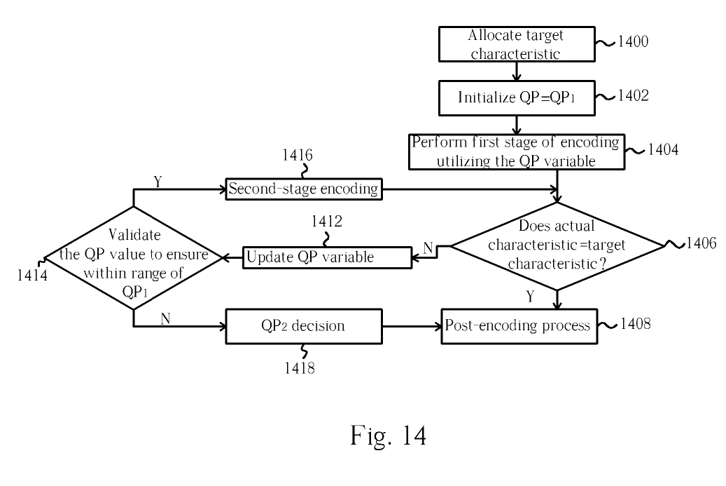

It should be noted that other embodiments of the present invention are also possible. For example, FIG. 14 illustrates a flowchart of a generalized method of operational frame-layer rate control based on a two-stage encoding scheme according to an exemplary embodiment of the present invention. The operational rate control method ensures that the encoding process meets a target characteristic being allocated for each frame before the frame is encoded. Provided that substantially the same result is achieved, the steps of the flowchart in FIG. 14 need not be in the exact order shown and need not be contiguous, that is, other steps can be intermediate. In this embodiment, operational frame-layer rate control includes the following steps:

Step 1400: Allocate a target characteristic for the current frame.

Step 1402: Initialize a QP variable to be equal to a starting value of the first quantization parameter QP₁. For example, the first quantization parameter QP₁ can be the QP or the average QP value of the previous frame.

Step 1404: Perform the first stage of encoding utilizing the QP variable being equal to the first quantization parameter QP₁ as initialized at step 1402 to thereby generate a residual signal and an actual characteristic for the current frame.

Step 1406: Test conditions for early termination by testing whether or not the actual characteristic for the current frame corresponding to being encoded with the first quantization parameter QP₁ in step 1404 is within a predetermined range of the target characteristic allocated for the current frame in step 1400. If the target characteristic is within the predetermined range of the target characteristic, proceed to step 1408; otherwise, proceed to step 1412.

Step 1408: Perform required post-encoding process to thereby generate an outgoing video bit stream.

Step 1412: Update the QP variable for the next iteration.

Step 1414: Validate the QP value to ensure it is within a predetermined range of the first quantization parameter QP₁.

Step 1416: Perform the second stage of encoding utilizing the updated QP variable.

Step 1418: Decide on a second quantization parameter QP₂ according to the previous results of the second stage of encoding.

At step 1406, if the target characteristic is within the predetermined range of the target characteristic, at step 1408 the outgoing video bit stream is generated according to the residual signal being encoded with the first quantization parameter. After step 1406, if the actual characteristic is not within the predetermined range of the target characteristic, a second quantization parameter QP₂ is found by performing a second encoding stage (step 1416) to encode the residual signal for the current frame generated during the first encoding stage. In this embodiment, the second encoding stage (step 1416) comprises encoding the residual signal for the current frame by utilizing the QP variable, which is different than the first quantization parameter QP₁ to thereby generate a corresponding second residual signal and a second actual characteristic. Step 1406 is then performed again to test if the second actual characteristic is within the predetermined range of the target characteristic. In this situation, a video bit stream is generated in step 1408 according to the second residual signal.

If the second actual characteristic is not within the predetermined range of the target characteristic, the second encoding stage is repetitively executed and thereby comprises encoding the residual signal for the current frame with a plurality of different QP variables to thereby generate a corresponding plurality of second residual signals and second actual characteristics. After generating each second actual characteristic, step 1406 is again performed, and if encoding the residual signal for the current frame by utilizing a particular QP variable generates a corresponding second actual characteristic being within the predetermined range of the target characteristic, the particular QP variable is chosen as a chosen quantization parameter for use in step 1408 when generating the video bit stream for the current frame. To ensure efficient operation and reduce encoding complexity, if the corresponding second actual characteristic is within the predetermined range of the target characteristic, control is passed from step 1406 to step 1408 so that the video bit stream can be generated according to the corresponding second residual signal without again encoding the residual signal.

At step 1418, if all of the second actual characteristics are above the predetermined range of the target characteristic, or if all of the second actual characteristics are below the predetermined range of the target characteristic, a second quantization parameter is chosen corresponding to the second actual characteristic being closest to the predetermined range as a chosen quantization parameter for generating the video bit stream for the current frame in step 1408. Alternatively, if at least one second actual characteristic is above the predetermined range of the target characteristic, at least one second actual characteristic is below the predetermined range of the target characteristic, and no second actual characteristics are within the predetermined range of the target characteristic, a second quantization parameter is chosen corresponding to the second actual characteristic being above and closest to the predetermined range as a chosen quantization parameter for generating a video bit stream for the current frame.

Concerning step 1400, in a first embodiment, allocating the target characteristic for the current frame comprises allocating a target number of bits for the current frame; and the actual characteristic comprises an actual number of bits being required for the current frame after being encoded. In a second embodiment, allocating the target characteristic for the current frame comprises allocating a target number of bits and a target distortion for the current frame; and the actual characteristic comprises an actual number of bits and an actual distortion of the current frame after being encoded. It should also be noted that the buffer status should be monitored during the encoding process when choosing the second quantization parameters in step 1418. That is, if the buffer either overflows or underflows when encoding the residual signal with the chosen second quantization parameter, a different second quantization parameter corresponding to the second actual characteristic closet to the predetermined range without buffer overflow and underflow is chosen as another chosen quantization parameter for generating a video bit stream for the current frame. It should also be noted that in a second embodiment, allocating the target characteristics comprises allocating a target distortion and a target number of bits.

Embodiments of a method of frame-layer rate control in a video encoder are disclosed for ensuring that the encoding process meets a target characteristic being allocated for each frame before the frame is encoded. By allocating a target characteristic for a current frame, performing a first encoding stage for encoding macroblocks of the current frame by utilizing a first quantization parameter to thereby generate a residual signal and an actual characteristic for the current frame corresponding to being encoded according to the first quantization parameter, and testing whether or not the actual characteristic for the current frame corresponding to being encoded with the first quantization parameter is within a predetermined range of the target characteristic for the current frame, the operational frame-layer rate control avoids performing complicated and inaccurate estimation of values such as MAD and/or variance of the residual signal. Furthermore, accuracy and desired target characteristics can be guaranteed even when video sequences contain frames with variable and hard to estimate properties.

Certain terms are used throughout the prior description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of frame-layer rate control in a video encoder, the method comprising:
allocating a target characteristic for a current frame;
performing a first encoding stage for encoding macroblocks of the current frame by utilizing a first quantization parameter to thereby generate a residual signal and an actual characteristic for the current frame corresponding to being encoded according to the first quantization parameter; and
testing whether or not the actual characteristic for the current frame corresponding to being encoded with the first quantization parameter is within a predetermined range of the target characteristic for the current frame.

2. The method of claim 1, further comprising if the actual characteristic is within the predetermined range of the target characteristic, generating a video bit stream according to the residual signal being encoded with the first quantization parameter.

3. The method of claim 1, further comprising if the actual characteristic is not within the predetermined range of the target characteristic, finding a second quantization parameter by performing a second encoding stage to encode the residual signal for the current frame.

4. The method of claim 3, wherein the second encoding stage comprises encoding the residual signal for the current frame by utilizing a quantization parameter being different than the first quantization parameter to thereby generate a corresponding second residual signal and a second actual characteristic; and if the second actual characteristic is within the predetermined range of the target characteristic, generating a video bit stream according to the second residual signal.

5. The method of claim 3, wherein the second encoding stage comprises encoding the residual signal for the current frame by utilizing a plurality of different second quantization parameters to thereby generate corresponding second residual signals and second actual characteristics.

6. The method of claim 5, further comprising determining a particular second quantization parameter which generates a corresponding second actual characteristic being closest to the target characteristic among the plurality of different second quantization parameters, and choosing the particular second quantization parameter for generating a video bit stream for the current frame.

7. The method of claim 5, further comprising testing if the corresponding second actual characteristic is within the predetermined range of the target characteristic immediately after encoding the residual signal, and if the corresponding second actual characteristic is within the predetermined range of the target characteristic, generating the video bit stream according to the corresponding second residual signal without again encoding the residual signal with another second quantization parameter.

8. The method of claim 5, further comprising if all of the second actual characteristics are not within the predetermined range of the target characteristic, choosing a second quantization parameter corresponding to the second actual characteristic being closest to the predetermined range as a chosen quantization parameter for generating a video bit stream for the current frame.

9. The method of claim 5, further comprising if at least one second actual characteristic is above the predetermined range of the target characteristic, at least one second actual characteristic is below the predetermined range of the target characteristic, and no second actual characteristics are within the predetermined range of the target characteristic, choosing a second quantization parameter corresponding to the second actual characteristic being above and closest to the predetermined range as a chosen quantization parameter for generating a video bit stream for the current frame.

10. The method of claim 9, further comprising if a buffer utilized during the encoding process overflows when encoding the residual signal with the chosen second quantization parameter, choosing another second quantization parameter corresponding to the second actual characteristic closet to the predetermined range of the target characteristic without buffer overflow and underflow as the chosen quantization parameter for generating a video bit stream for the current frame.

11. The method of claim 3, further comprising ensuring the second quantization parameter is within a predetermined range of the first quantization parameter.

12. The method of claim 3, wherein the residual signals of intra macro blocks (MBs) are refined using the neighboring reconstructed pixels in the second stage of encoding.

13. The method of claim 1, wherein allocating the target characteristic for the current frame comprises allocating a target number of bits for the current frame; and the actual characteristic comprises an actual number of bits being required for the current frame after being encoded.

14. The method of claim 13, wherein allocating the target characteristic for the current frame further comprises allocating a target distortion for the current frame; and the actual characteristic further comprises an actual distortion of the current frame after being encoded.

15. The method of claim 14, further comprising:
if encoding the residual signal for the current frame by utilizing a particular second quantization parameter generates a corresponding second actual distortion being within the predetermined range of the target distortion, choosing the particular second quantization parameter as a chosen quantization parameter;
if an actual number of bits for the current frame after being encoded utilizing the chosen quantization parameter is not within a predetermined range of the target number of bits, adjusting the chosen quantization parameter to thereby adjust the actual number of bits closer to the target number of bits; and
re-encoding the residual signal by utilizing the adjusted quantization parameter for generating a video bit stream for the current frame.

16. The method of claim 1, wherein the predetermined range of the target characteristic comprises an upper bound and a lower bound, and the upper bound being a reciprocal of the lower bound.

17. The method of claim 1, further comprising determining the first quantization parameter by averaging the quantization parameters for all macroblocks in a previous frame.

18. The method of claim 1, the method being used to provide frame-layer rate control for an H.264 video encoder.

19. An apparatus for performing frame-layer rate control in a video encoder, the apparatus comprising:
a target characteristic allocating unit for allocating a target characteristic for a current frame;
a first stage encoding device being coupled to the target characteristic allocating unit for performing a first encoding stage for encoding the current frame by utilizing a first quantization parameter to thereby generate a residual signal and an actual characteristic for the current frame corresponding to being encoded according to the first quantization parameter; and
a rate control device being coupled to the first stage encoding device for testing whether or not the actual characteristic for the current frame corresponding to being encoded with the first quantization parameter is within a predetermined range of the target characteristic for the current frame.

20. The apparatus of claim 19, wherein the video encoder is for generating a video bit stream according to the residual signal being encoded with the first quantization parameter if the rate control device determines that the actual characteristic is within the predetermined range of the target characteristic.

21. The apparatus of claim 19, further comprising a second stage encoding device being coupled to the rate control device; the second stage encoding device for finding a second quantization parameter by performing a second encoding stage to encode the residual signal for the current frame if the rate control device determines that the actual characteristic is not within the predetermined range of the target characteristic.

22. The apparatus of claim 21, wherein the second stage encoding device is further for encoding the residual signal for the current frame by utilizing a quantization parameter being different than the first quantization parameter to thereby generate a corresponding second residual signal and a second actual characteristic; and the video encoder is for generating a video bit stream according to the second residual signal if the second actual characteristic is within the predetermined range of the target characteristic.

23. The apparatus of claim 21, wherein the second stage encoding device is further for encoding the residual signal for the current frame by utilizing a plurality of different second quantization parameters to thereby generate a plurality of corresponding second residual signals and second actual characteristics.

24. The apparatus of claim 23, wherein the rate control device is further for determining a particular second quantization parameter as a chosen quantization parameter for generating a video bit stream for the current frame if encoding the residual signal for the current frame by utilizing the particular second quantization parameter generates a corresponding second actual characteristic being closest to the target characteristic among the plurality of different second quantization parameters during the second encoding stage.

25. The apparatus of claim 23, wherein the rate control device is further for testing if the corresponding second actual characteristic is within the predetermined range of the target characteristic immediately after encoding the residual signal to generate the corresponding second residual signal, and if the corresponding second actual characteristic is within the predetermined range of the target characteristic, the video encoder is for generating the video bit stream according to the corresponding second residual signal without again encoding the residual signal with another second quantization parameter.

26. The apparatus of claim 23, wherein the rate control device is further for choosing a second quantization parameter corresponding to the second actual characteristic being closest to the predetermined range as a chosen quantization parameter for generating a video bit stream for the current frame if all of the second actual characteristics are not within the predetermined range of the target characteristic.

27. The apparatus of claim 23, wherein the rate control device is further for choosing a second quantization parameter corresponding to the second actual characteristic being above and closest to the predetermined range as a chosen quantization parameter for generating a video bit stream for the current frame if at least one second actual characteristic is above the predetermined range of the target characteristic, at least one second actual characteristic is below the predetermined range of the target characteristic, and no second actual characteristics are within the predetermined range of the target characteristic.

28. The apparatus of claim 21, further comprising a buffer being coupled to the second stage encoding device utilized during the encoding process of the second encoding stage;
wherein if the buffer either overflows or underflows when encoding the residual signal with the second quantization parameter, the rate control device chooses another second quantization parameter corresponding to the second actual characteristic closet to the predetermined range of the target characteristic without buffer overflow and underflow for generating a video bit stream for the current frame.

29. The apparatus of claim 21, wherein the rate control device is further for ensuring the second quantization parameter is within a second predetermined range of the first quantization parameter.

30. The apparatus of claim 21, wherein the rate control device is further for refining residual signals of intra macro blocks (MBs) utilizing neighboring reconstructed pixels in the second encoding stage.

31. The apparatus of claim 19, wherein the target characteristic allocating unit is for allocating the target characteristic for the current frame being a target number of bits for the current frame; and the actual characteristic comprises an actual number of bits being required for the current frame after being encoded.

32. The apparatus of claim 31, wherein the target characteristic allocating unit is further for allocating the target characteristic for the current frame being a target distortion for the current frame; and the actual characteristic further comprises an actual distortion of the current frame after being encoded.

33. The apparatus of claim 32, wherein the rate control device is for choosing the particular second quantization parameter as a chosen quantization parameter if encoding the residual signal for the current frame by utilizing a particular second quantization parameter generates a corresponding second actual distortion being within the predetermined range of the target distortion, adjusting the chosen quantization parameter to thereby adjust the actual number of bits closer to the target number of bits if an actual number of bits for the current frame after being encoded utilizing the chosen quantization parameter is not within a second predetermined range of the target number of bits, and re-encoding the residual signal by utilizing the adjusted quantization parameter for generating a video bit stream for the current frame.

34. The apparatus of claim 19, wherein the predetermined range comprises an upper bound and a lower bound, and the upper bound being a reciprocal of the lower bound.

35. The apparatus of claim 19, wherein the first stage encoding device is further for determining the first quantization parameter by averaging the quantization parameters for all macroblocks in a previous frame.

36. The apparatus of claim 19, wherein the video encoder is an H.264 video encoder.
